(19) United States
(12) Patent Application Publication
(10) Pub. No.: US 2005/0062953 A1
(43) Pub. Date: Mar. 24, 2005

(54) Method for measuring distance

(76) Inventor: Michael Beuschel, Koesching (DE)

Correspondence Address: FASSE PATENT ATTORNEYS, P.A., P.O. BOX 726, HAMPDEN, ME, 04444-0726, US

(21) Appl. No.: 10/497,038

(22) PCT Filed: Nov. 30, 2002
(86) PCT No.: PCT/DE02/04400

(30) Foreign Application Priority Data
Dec. 22, 2001 (DE) 101 63 925.2

(51) Int. Cl. G01C 3/00; G01C 5/00; G01C 3/08

(52) U.S. Cl. 356/4.01; 356/3

(57) ABSTRACT

In the determination of the distance of an object from the sampled measured values of a CV-sensor, a drift of the result is caused by several effects. Previously, for example, the approach is pursued, to use a temperature dependent correction function or table for the calculated distance values. For that purpose, a calibration of each sensor is necessary within the scope of the production due to component dispersions or deviations. Other effects other than temperature drift are not taken into account thereby, or signify a considerable additional effort or expense (for example in connection with dependence on the emitter power). Method for the spacing distance measurement with an active optical sensor arrangement in a vehicle, whereby the spacing distance is measured by means of pulse transit time method and sampling of the received signals, a spacing distance correction value is ascertained for the measured spacing distance, and the sensor arrangement is arranged in a housing, characterized in that the spacing distance correction value is ascertained in connection with stray light that is conditioned on or subject to construction and dependent on installation location. The inventive method is especially suitable as an evaluation method for optical precrash sensors in vehicles.

The invention relates to a method for the separation or spacing distance measurement with an active optical sensor arrangement according to the preamble of the patent claim 1. The inventive method is especially suitable as an evaluation method for optical precrash sensors in vehicles.

In order to improve the safety in road traffic, optical sensor arrangements are increasingly installed as obstacle warning systems in vehicles, which, for supporting or assisting the driver and the occupant protection system, predominantly detect the immediate surrounding environment in front of the moving vehicle and warn of danger sources such as, for example, stationary or moving obstacles on the roadway. For this purpose, for example so-called CV sensors (Closing Velocity, approaching speed) are used, which work based on a spacing distance measurement by means of pulse transit time methods and sampling of the received signals. Thus, the following explanations relate to this application, but are also utilizable in connection with other sensors of comparable type.

In the determination of the distance of an object from the sampled measured values of a CV sensor, a drift of the result is caused by several effects:
The transit times of the trigger electronics vary with the temperature.
The pulse form of the emitter changes in amplitude and form with the temperature.
The characteristic values of the utilized components (and therewith the frequency response and transit time of the circuit) are temperature dependent and subject to a dispersion.

For the calibration of the distance measurement, a reference measurement with an object in a known spacing distance is needed for each operating condition.

The difference between the calculated distances of the known object and the calculated distances to a different object then always or constantly corresponds to the actual distance difference between both objects. By addition of the distance of the known object, the absolute distance of the unknown object is determined. Thereby, the spacing distance measurement is calibrated.

Previously the approach is pursued, for example, to utilize a temperature dependent correction function or table for the calculated distance values. For this purpose, a calibration of each sensor is necessary within the scope of the production due to component dispersions or scatterings. Other effects other than temperature drift are not taken into account in that context, or signify a considerable additional effort or expenditure (for example in connection with dependence on the emitter power).

Furthermore, an apparatus and a method for the distance measurement in a vehicle are described in the DE 195 41 448 A1. From that it is known to determine the distance by evaluation of the signal flank. It is taught, to mask or screen out all close range reflections through a time-variable threshold value level. This time-variable threshold, however, causes errors in the spacing distance determination, which must be corrected with great effort or expense.

The object underlies the invention, to set forth a method for the distance measurement with an optical sensor arrangement according to the preamble of the claim 1, with which an automatic distance calibration is made possible.

This object is achieved by a method with the characterizing features set forth in the claim 1.

The method according to claim 1 comprises the advantages, that an automatic calibration of the distance can be carried out in a simple manner and by simple means, without hereby giving rise, as known from the state of the art, to new errors for the distance measurement, which on their part must again be corrected with effort or expense.

Advantageous embodiments of the method according to claim 1 are set forth in the dependent claims.

The invention will now be explained in connection with an example embodiment with the aid of the drawing.

It is shown by:

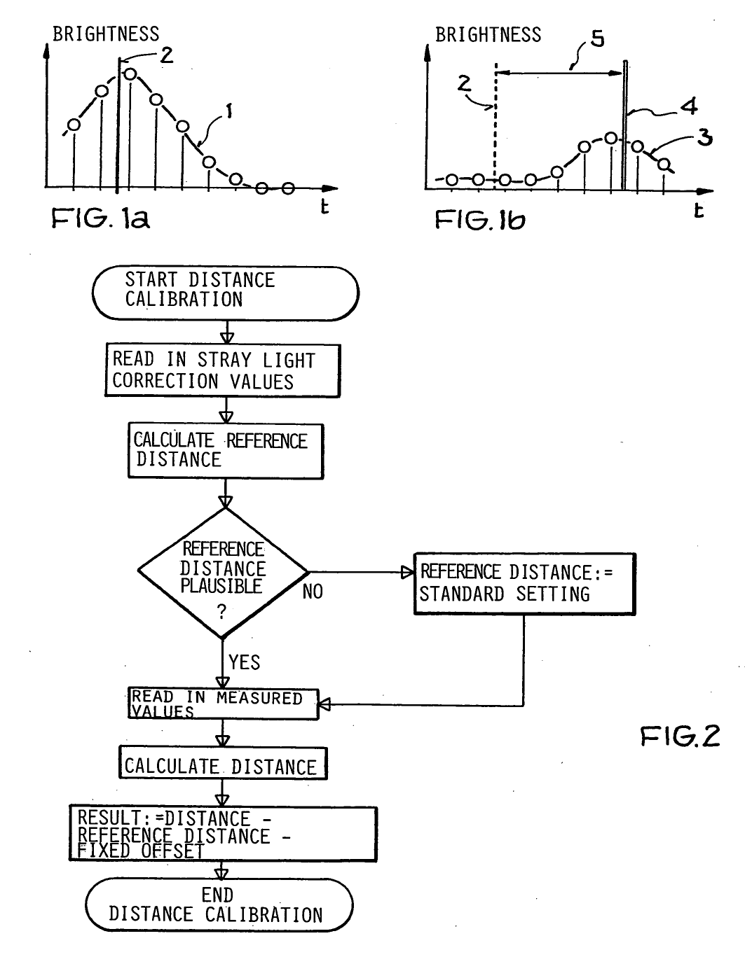

FIG. 1a: a diagram with the time sequence or progression of the brightness or intensity of interfering or stray light correction values from a stray light correction and a reference distance ascertained from these stray light correction values;

FIG. 1b: a diagram with the time sequence of the brightness of corrected sampled values, the reference distance from FIG. 1a, the object distance ascertained from the corrected sampled values, and the calibrated object distance; and

FIG. 2: a flow diagram with the inventive algorithm for the distance calibration.

The FIG. 1a shows a time diagram that includes a curve 1 with the brightness of interfering or stray light correction values from a stray light correction and a reference distance 2 ascertained from these stray light correction values. In this context, the stray light correction values are acquired from a previously carried-out stray light correction, as is known, for example, from the publication DE 41 41 469 A1.

Besides a previously carried-out stray light correction, the inventive solution is based additionally on the following assumptions:
Reflections exist within the sensor housing and on the transparent sensor covering (for example windshield, headlight cover, including soiling) in the measurable range (that is to say the amplitude of these signal components is not too small).
The signal components produced thereby are always or constantly considerably greater than all other stray light components (for example due to engine hood, fog).
In comparison to the stray light component, only small electrical crosstalk and small asymmetry of the individual measured values arises.
The stray light correction is adapted at regular spacings or intervals.

In connection therewith, the mentioned stray light components can be interpreted as reflected light of a very close (fictitious) object and thus used as a reference measurement or reference distance 2. The actual spacing distance of this fictitious reference object is conditioned or dependent on the construction and can be stored as a fixed parameter in the sensor.

In FIG. 1b, a time diagram is illustrated, which contains the brightness of corrected sampled values in a curve 3, the object distance 4 ascertained from these corrected sampled values, and the reference distance 2 from FIG. 1a. The calibrated object distance symbolized by an arrow 5 arises out of the difference between the object distance 4 ascertained from the corrected sampled values and the reference distance 2.

FIG. 2 shows a flow diagram with the inventive algorithm for the distance calibration. During the operation, a fictitious distance 2 is calculated (for example by center of mass formation of the stray light correction values) from the stored stray light correction values of the curve 1 in FIG. 1a of the stray light correction, at regular spacings or intervals, analogous to the sampled measured values. This distance 2 is subtracted as an offset from all calculated object distances, thus of the object distance 4 in FIG. 1b.

Because the stray light component is dependent also on external factors, the following measures should be provided for avoiding false or erroneous measurement results:
Testing of the amplitude of the stray light correction values according to curve 1 in FIG. 1a as to plausibility (for example minimum value, unambiguous maximum).
Limiting of the evaluated stray light correction values from curve 1 to a certain defined distance range.
Testing of the permitted range of the reference distance 2 (minimum and maximum possible fictitious distance).
Low pass filtering of the reference distance 2 and bounding or limiting of the maximum (positive) gradient (maximum change per unit time) thereof.
Comparison of the reference distances 2 of all channels in multichannel measurement.

If one of these plausibility tests turns out negative, either the last reliable distance correction value or a standard setting can be reverted to, or the reference distance is determined as a function of previous reference distances that were ascertained with positive plausibility test. As a further calibration or compensation, a fixed offset that is permanently stored or ascertained during the production can be provided as the reference distance 2.

In stationary measurements, that is to say for a stationary vehicle, an invalid (that is to say too large) reference distance is ascertained; for this operating range, however, no measurements of the CV-sensor are specified, because a resting object represents no collision danger. If nonetheless a further object approaches with a high speed, a speed can nevertheless be ascertained, because the signal component due to the moving object, is not suppressed by the stray light correction. Merely the measured distance is given out too low.

If, in contrast, the previously resting object disappears out of the field of view of the sensor, the values of the stray light correction are adapted very quickly to the relevant values. Thereby, a correct reference distance can again be determined.

The proposed algorithm is also suitable under certain circumstances for a coarse indirect measurement of the temperature in connection with a known temperature dependence of the distance drift. This would also obviate a possibly needed temperature sensor.

Since the described algorithm builds on a stray light correction, both algorithms are to be tuned or coordinated with respect to one another. Especially, a sufficiently slow behavior of the adaptation of the stray light correction is to be provided.

If no reliably arising, or only too-small stray light components of the previously mentioned type are present, an additional component can be fed-back through suitable optical layout or design.

REFERENCE NUMBER LIST

| | |
|---|---|
| 1 | brightness correction values |
| 2 | ascertained reference distance |
| 3 | brightness corrected sampled values |
| 4 | measured object distance |
| 5 | calibrated object distance |

1. Method for the spacing distance measurement with an active optical sensor arrangement in a vehicle, whereby the spacing distance is measured by means of pulse transit time method and a spacing distance correction value is ascertained for the measured spacing distance, characterized in that the spacing distance correction value is ascertained in connection with stray light that is conditioned on or subject to construction and dependent on installation location.

2. Method according to claim 1, characterized in that the spacing distance correction value is subtracted from the measured spacing distance.

3-7. (canceled).

8. Method according to claim 1, characterized in that, before the ascertaining of the spacing distance correction value, a stray light correction for the determining of stray light correction values is carried out.

9-12. (canceled).

13. Method according to claim 1, characterized in that furthermore a fixed offset is subtracted from the measured spacing distance.

14. Method according to claim 1, characterized in that the spacing distance correction value is ascertained in connection with a reference distance determined by a reference measurement.

15. Method according to claim 14, characterized in that the sensor arrangement is arranged in a housing and the reference measurement is carried out in connection with reflections within the sensor housing.

16. Method according to claim 14, characterized in that the reference measurement is carried out in connection with reflections on the windshield, the headlight cover or the vehicle body of the vehicle.

17. Method according to claim 14, characterized in that an additional component is fed-back for the reference measurement by suitable optical design.

18. Method according to claim 8, characterized in that the spacing distance correction value is ascertained in connection with a reference distance determined by a reference measurement, and the reference distance is determined from the stray light correction values.

19. Method according to claim 18, characterized in that the reference distance is tested for plausibility.

20. Method according to claim 19, characterized in that, for a plausibility test turning out negative, the reference distance is set to a standardized preset value.

21. Method according to claim 19, characterized in that, for a plausibility test turning out negative, the reference distance is determined as a function of preceding reference distances ascertained with positive plausibility test.
